(19) United States
(12) Patent Application Publication
(10) Pub. No.: US 2004/0215530 A1
(43) Pub. Date: Oct. 28, 2004

(54) Method for providing point of sale information regarding a product in a store

(75) Inventors: Brian Rawson, Wichita, KS (US); Bill Nabors, Wichita, KS (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: The Coleman Company, Inc., Wichita, KS (US)

(21) Appl. No.: 10/423,557

(22) Filed: Apr. 25, 2003

(51) Int. Cl. G06F 17/60

(52) U.S. Cl. 705/27

(57) ABSTRACT

A method by which a manufacturer may provide point of sale information to a potential customer while the potential customer is in a store. In response to a potential customer's action while in the store, the manufacturer may provide audio, video or pictorial information about its products on a personal computing device associated with the potential customer. The action by the potential customer may be moving to a particular location within the store, dialing a telephone number provided on the manufacturer's product, scanning a product code on the product, or otherwise communicating access information related to the product to the system of the present invention.

### TECHNICAL FIELD OF THE INVENTION

The present invention relates to a method of doing business, and more particularly to the method of inducing a potential customer into a sales transaction.

### BACKGROUND OF THE INVENTION

Manufacturers of consumer products spend millions of dollars a year trying to educate consumers about their products. The manufacturers have television and radio commercials, newspaper advertisements, mailers, and other methods of trying to directly contact potential customers. In addition, many manufacturers now offer information about their products on web sites.

Despite the readily available information about many manufacturers' products, often the decision regarding purchasing a product, or in particular which product will be purchased, is made while a consumer is at a store. This fact can often be frustrating for a manufacturer, because the information available to a potential customer at the store is often limited. The manufacturer may print a number of items on packaging for its product, but too much information may be overwhelming for a potential customer, or may make the information hard to digest. Thus, consumers often make their purchase decisions based upon the location of the product in the store, the price of the product, or artistic detail on the outside of the packaging. There exists a need for a better way of providing information about products in a store setting so that a manufacturer may properly educate a potential customer about its products.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a method by which a manufacturer may provide point of sale information to a potential customer while the potential customer is in a store. To this end, in response to a potential customer's action while in the store, the manufacturer may provide audio, video or pictorial information about its products on a personal computing device associated with the potential customer.

The action by the potential customer may be moving to a particular location within the store, dialing a telephone number provided on the manufacturer's product, scanning a product code on the product, or otherwise communicating access information related to the product to the system of the present invention. In response to the product access information being supplied, the system of the present invention provides product information to the potential customer's personal computing device. In accordance with one embodiment of the present invention, a telephone number is provided on the product, and the potential customer is invited to call the telephone number so as to be provided information about the product.

The product information provided by the system to the personal computing device may be a video displayed on a cell phone, or another type of personal computing device. Additionally, a recorded voice message may provide information regarding the product. A link to a web site may be provided. Options may be provided so that a potential customer may select from several different available information packages.

Incentives may be provided to induce a potential customer to access the manufacturer's product information, such as a chance to win a free product, entry into a sweepstakes, or other incentives. Other commercials or advertisements may be provided along with the information, and those commercials or advertisements may be a potential revenue stream for the manufacturer of the product.

If desired, the manufacturer's product information may be tailored to a particular store. For example, if known competitors' products are adjacent to the manufacturer's product, then the manufacturer's product information may compare and contrast its product to products that are on adjacent shelves.

Other advantages will become apparent from the following detailed description when taken in conjunction with the drawings, in which:

### BRIEF DESCRIPTION OF THE DRAWINGS

FIG. 1 is a functional block diagram generally illustrating a computing device which may be used in the illustrative method of the invention;

FIG. 2 is a diagrammatic representation of an implementation of the present invention, in which a potential customer is urged to call a number printed on a package of a product to receive information about the product;

FIG. 3 is a diagrammatic representation of another implementation of the present invention, in which a scanner on a computing device receives information about a product by scanning a product code on the product;

FIG. 4 is a diagrammatic representation of another implementation of the present invention, in which an infrared transmitter provides information about a product to a computing device;

FIG. 5 is a diagrammatic representation of a floor plan of a store in which another embodiment of the present invention may be implemented;

FIG. 6 is a representation of a link that may be provided on a computing device in accordance with one aspect of the present invention;

FIG. 7 is a representation of an advertisement that may be provided on a computing device in accordance with one aspect of the present invention; and

FIG. 8 generally shows steps for providing point of sale information to a potential customer in accordance with an embodiment of the present invention.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention.

Generally described, the present invention provides a method of providing detailed information about a product. A potential customer, through some action, indicates that the potential customer desires product information to be provided to a personal computing device associated with the potential customer. The action may be, for example, that the potential customer is adjacent to or in the vicinity of the product in a store. This action, or a combination of this action and additional input by the potential customer, causes a recorded message to be provided to a computing device associated with the potential customer. The computing device may be, for example, a cell phone, a personal digital assistant (“PDA”), or other computing devices, further described below. The potential customer action may be the dialing of a telephone number that is provided on packaging for the product, approaching a product and having the location of the potential customer sensed by some type of system (e.g., GPS), scanning a bar code or other product code on the product with a product code reader on the personal computing device, or other methods described below. The recorded message that is provided to the potential customer may be any number of different things, including an email or text message, a link to a web site, a recorded verbal message, or a video. Other options are described below.

Exemplary Computing Device

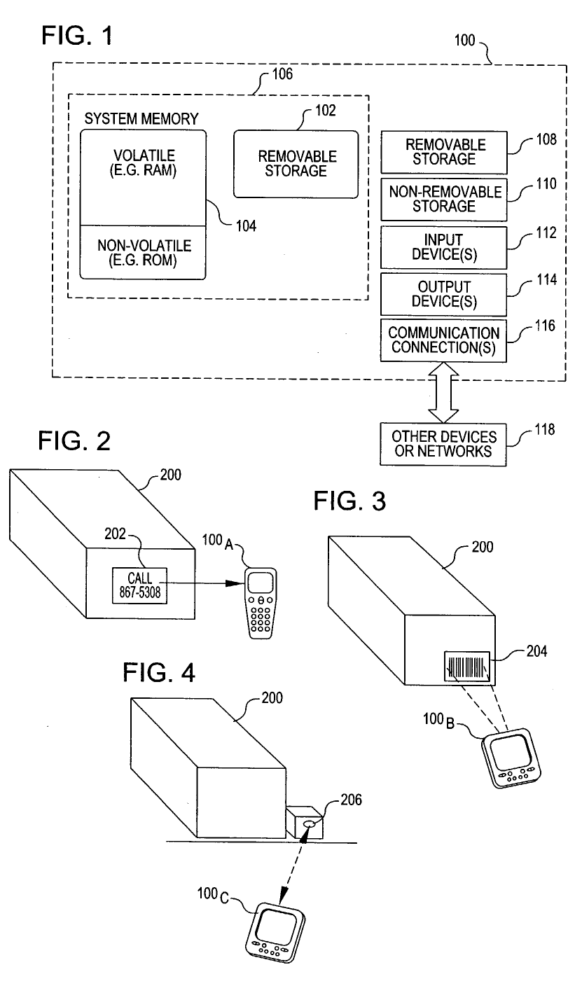

FIG. 1 is a functional block diagram generally illustrating a computing device 100, one or more of which may be adapted for use in the illustrative method for implementing the invention. The computing device 100 may be, for example, a personal computer, a handheld device such as a cell phone or a personal digital assistant (PDA), a wearable computer, microprocessor-based or programmable consumer electronics, and the like. In one embodiment of the invention, the computing device 100 may be owned by a potential customer, wherein the computing device would be carried by the customer into a store. Non-limiting examples include a PDA, a cell phone, or a microprocessor-based watch. In another embodiment of the invention, a store owner may provide the computing device 100 on a shopping cart or for a potential customer to carry while in the store.

In its most basic configuration, the computing device 100 is a cell phone, capable of sending and/or receiving telephone calls. At another level, the computing device 100 may include at least one processing unit 102 and system memory 104. Depending on-the exact configuration and type of computing device, system memory 104 may be volatile (such as RAM), non-volatile (such as ROM, flash memory, etc.) or some combination of the two. The basic configuration of the device 100 is illustrated in FIG. 1 within dashed line 106.

The computing device 100 may also have additional features and functionality. For example, the computing device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules, or other data. System memory 104, removable storage 108, and non-removable storage 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 100. Any such computer storage media may be part of device 100.

The computing device 100 may include one or more input devices 112 such as a keyboard, mouse, pen, puck, voice input device, touch input device, scanner, or the like. One or more output devices 114 may also be included, such as a video display, audio speakers, a printer, or the like. Input and output devices are well known in the art and need not be discussed at length here.

The computing device 100 may also contain a communications connection 116 that allows the device 100 to communicate with other devices 118, such as over a local (LAN) or wide area network (WAN). The communications connection 116 may be used, for example, to access and retrieve the product information. Communications connection 116 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term “computer readable media” as used herein includes both storage media and communication media.

Action by a Potential Customer

There are a variety of actions that may be taken by a potential customer in conjunction with the computing device 100 that may cause the computing device 100 to receive a recorded message. As an example, as shown in FIG. 2, a manufacturer may provide a product 200 with a label 202 having a telephone number thereon. The label 202 may prominently display an eye-catching instruction to a passing potential customer to stop and call the telephone number so as to receive information about the product 200. Instructions on the package may direct the potential customer to call the number from his or her cell phone 100_{A} or other computing device while in the aisle of the retail store. The telephone number given could be toll-free, or could be a local number. Calling the number may result in the playing of a recorded message, further described below. The potential customer may be prompted to enter a unique code assigned to the product 200, which may be written on the product or label 202 for example, so that the recorded message communicated to the potential customer may be tailored for the specific product. In addition, the code or specific number may be tailored for the product 200 at a specific retailer, further described below. The unique code may be printed, for example, on the package near the telephone number. Alternatively, unique telephone numbers may be assigned for each product.

As used herein, “product” is meant to denote any item or items that may be purchased by a consumer. Thus, information or a message may be provided to a potential consumer about, for example, services, physical products that are available for viewing, or products or services that are available for order. However, for ease of reference, the term “product” will be used herein.

As an alternative action by a potential customer, a computing device 110_{B} (FIG. 3) may be provided with a scanner, such as a standard product code scanner (not shown, but known in the art). The package of the product 200 may be provided with a scan code, such as a bar code 204 (FIG. 3). By scanning the bar code 204, the computing device 100_{B} is provided may be provided with product information, or with access information about the product 200. This access information may be transmitted to a remote location, by cell phone technology, a WAN or LAN, and in response, the user may receive product information (e.g., a recorded message).

As used herein, “access information” may be any information that permits the computing device 100, with or without additional user input, to retrieve product information. As non-limiting examples, for the example shown in FIG. 3, the scan may obtain access information which may be an identification of the product, a URL to a web site regarding the product, a telephone number similar to as described above, or other information.

In another embodiment of action that may be taken by a potential customer, shown in FIG. 4, an infrared transmitter 206 may be placed in close proximity to the product 200, and a potential customer may use a computing device 100_{c} to access information about the product 200 via the infrared transmitter 206. In this embodiment, the product information may be accessed through the infrared transmitter 206, and thus the only user action required is requesting a transmission of data from the infrared transmitter.

In still another embodiment, a system may be used for detecting the position of a potential customer within a retail store, and based upon that information, may make access information or product information available to the potential customer. The potential customer's computing device 100 may use current blue tooth technology, a global positioning system (“GPS”), a local positioning system, such as may be provided within the retail store 300 itself, or some other system that provides information about the location of the computing device 100.

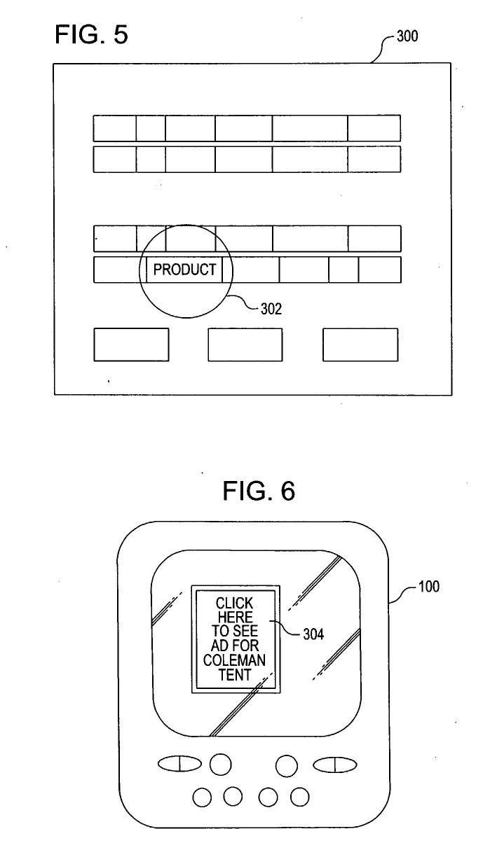

As an example, as shown in FIG. 5, a product 200 may be located in a particular position within a store 300. A zone 302 is defined in which a potential customer's computing device 100 automatically receives either access information or product information about a particular product 200. When the potential customer and his or her computing device 100 are in the zone 302, then information may be supplied to the computing device 100. The information provided may be product information, wherein additional action by the potential customer is not required. Alternatively, access information may be provided to the potential customer. As an example of access information, shown in FIG. 6, a button 304 may be provided that can be clicked to request product information (e.g., see an advertisement about the product 200). Alternatively, a telephone number may be provided on a telephone, or a link to a web site may be provided.

Other devices or methods may be used to provide information about a product 200 based upon a potential customer's presence or a potential customer's interaction with the product 200 or the environment of the product 200. As another example, a potential customer may be provided a number of links on a computing device 100 when the potential customer enters a store (e.g., the store 300). The link may be additionally include information about where a product may be found within the store. If desired, buttons or other components on or within the computing device 100 may be provided to delete the links or to follow the links to more information about a particular product. Also, if desired, this feature may be disabled on a computing device 100 so that unwanted messages or indications will not be received by the potential customer.

Message Provided to Potential Customer

As described above, the message may be any number of different sources of information that can be provided to a potential customer as an advertisement for, or information about, a product (e.g., the product 200). For example, in the telephone number example described above, a caller may be invited to listen to a recorded message. The recorded message may be an advertisement to buy the product, or a detailed explanation of the features and benefits of the product. Also, if the potential customer's computing device 100 has video capabilities, a video advertisement or information about the product may be downloaded and may be viewed by the potential customer while the potential customer is shopping in the store.

The message may be customized for particular retailers, because of known competitive products within the store. For example, if a tent were for sale in a particular store, such as Wal-Mart, the advertisement or information about the product may include not only information about the product, but may compare and contrast the product to other similar products that are sold in the store. The potential customer may be directed to a web site that includes information, and if the computing device 100 has internet connectability, the potential customer may browse to the web site. In the telephone call example, the potential customer could be directed to a live operator who may be prepared to answer the caller's questions and to further build interest and confidence in the product.

If a recorded message is used, at the end of the recorded message a brief endorsement or advertisement could be added to promote another product or service. The manufacturer of the product may collect revenue or other compensation from the mobile telephone company, the company that provides service for the computing device 100, or related product companies in exchange for the endorsement or advertisement contained in the recorded message. In addition, the recorded message may include information regarding peripheral products that may be purchased with the product 200.

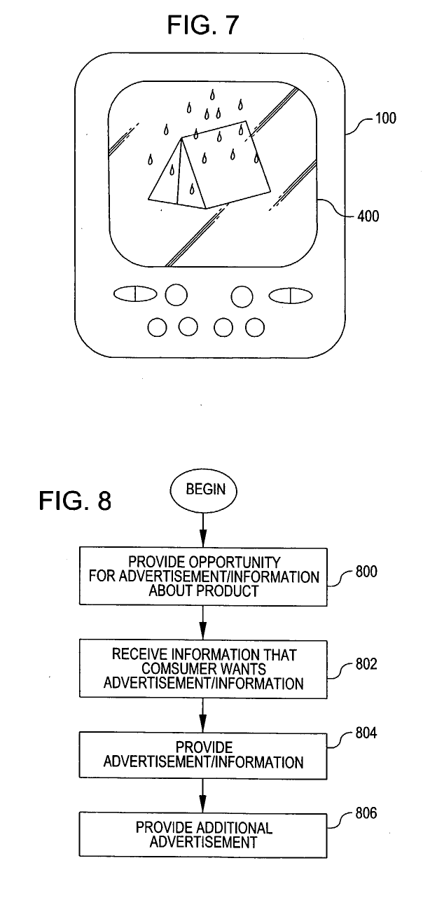

FIG. 7 shows an example of a computing device 100_{D} having an advertisement 400 displayed thereon. The advertisements may be part of a web site, or may be a video that is provided to a potential customer. If a video, then text or audio may be additionally provided that describes the product.

The Method of the Present Invention

FIG. 8 generally shows steps for providing point of sale information to a potential customer in accordance with one embodiment of the present invention. Beginning at step 800, the potential customer is provided an opportunity for an advertisement for, or information about, a particular product in a store. The opportunity seeks action of a potential customer, and the action may be provided in a variety of ways, such as by the various embodiments described above.

At step 802, the system receives information that the potential customer wants the advertisement or information about the product. This step occurs by the potential customer's action, which may be, for example, dialing a telephone number provided on the product, scanning a bar code on the product, or being positioned in the appropriate place within a store, and/or selecting a link for advertisement or information about the product.

At step 804, the advertisement or information about the product is provided, in the form of a message, as described above. If additional information is provided about additional products or advertisements, that information may be provided at step 806.

If desired, the potential customer may be requested to provide personal information, such as an address or phone number, so that potential customer may be added to a customer list, for example. This information may be maintained, for example, in a database, and may later be accessed. The information may be used, for example, to determine products that are of interest to a potential consumer, and advertising or purchasing opportunities may be made available to the potential consumer based upon products in which the consumer expresses an interest.

The present invention provides a method for providing detailed information at a point of sale for a potential customer. The information is not required to be printed on a product, and may be accessed by a potential customer using a computing device 100. The additional information may be helpful in making a decision regarding a purchase, and may sway a potential customer to make a purchase using an educated decision. Because most embodiments of the system require interaction from a potential customer, the information and/or advertisement is utilized by a potential customer only if that information is desired. Thus, the method is non-obtrusive, but still readily available for a willing potential customer.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A method of providing point of sale information to a potential customer, comprising:
receiving information that action with respect to a particular product in a store building has occurred with a computing device within the store building; and
in response to the information, sending a message about the particular product to the computing device.

2. The method of claim 1, wherein the action comprises calling a telephone number, and wherein sending the message comprises providing the message in response to calling the telephone number.

3. The method of claim 2, wherein the message comprises audio.

4. The method of claim 2, wherein the message comprises video.

5. The method of claim 2, further comprising, prior to receiving information, providing information regarding the action.

6. The method of claim 5, wherein providing information regarding the action comprises providing a phone number with the product.

7. The method of claim 6, wherein the phone number is provided on packaging for the product.

8. The method of claim 1, wherein the action comprises positioning the computing device within a defined range of the product.

9. The method of claim 8, wherein the action further comprises providing access information to the computing device responsive to positioning the computing device within the defined range of the product, and responsive to user selection of the access information, sending the message to the computing device.

10. The method of claim 1, wherein the action comprises providing access information to the computing device, and responsive to user selection of the access information, sending the message to the computing device.

11. The method of claim 1, wherein the message comprises audio.

12. The method of claim 1, wherein the message comprises video.

13. The method of claim 1, wherein the action comprises scanning a product code.

14. The method of claim 13, wherein the action further comprises receiving access information in response to scanning the product code, and responsive to user selection of the access information, sending the message to the computing device.

15. The method of claim 1, wherein the action comprises accessing information via an infrared transmitter.

16. The method of claim 1, further comprising providing an advertisement with the message.

17. The method of claim 1, wherein the message comprises information about the product.

18. The method of claim 1, wherein the message comprises a request for personal information, and further comprising maintaining a database of personal information.

19. A method of providing point of sale information to a potential customer, comprising:
providing access information about a product within a store to a computing device within the store;
responsive to user selection of the access information, sending a message about the product to the computing device.

20. The method of claim 19, wherein the user selection comprises calling a telephone number, and wherein sending the message comprises providing the message in response to calling the telephone number.

21. The method of claim 20, wherein the message comprises audio.

22. The method of claim 20, wherein the message comprises video.

23. The method of claim 19, wherein providing access information comprises providing a phone number with the product.

24. The method of claim 23, wherein the phone number is provided on packaging for the product.

25. The method of claim 19, wherein the message comprises audio.

26. The method of claim 19, wherein the message comprises video.

27. A method of providing point of sale information to a potential customer, comprising:
providing a phone number on packaging for a product and an invitation to call the number while shopping for products; and
in response to receiving a call at the telephone number, providing information indicative of the product.

28. The method of claim 27, further comprising providing an incentive for a potential customer to call the telephone number.

29. The method of claim 27, further comprising providing an advertisement with the information.

30. The method of claim 27, wherein the information comprises playing a message regarding the product.

31. The method of claim 27, wherein the information comprises a live operator that answers a call to the telephone number.
